(19) United States
(12) Patent Application Publication
(10) Pub. No.: US 2007/0175884 A1
(43) Pub. Date: Aug. 2, 2007

(54) Steam cooker with steam delivery device

(76) Inventors: Atul Saksena, Troy, OH (US); Kui-Chiu Kwok, Gurnee, IL (US); Jeffrey L. Frock, Troy, OH (US)

Correspondence Address: THOMPSON HINE LLP;Intellectual Property Group, P.O Box 8801, DAYTON, OH, 45401-8801, US

(21) Appl. No.: 11/344,525

(22) Filed: Jan. 31, 2006

(51) Int. Cl. F27D 11/00

(52) U.S. Cl. 219/400

(57) ABSTRACT

A steam cooker includes a steam cooking chamber including left, right, top, bottom and rear walls, a front access opening and a door moveable between an open position to allow access to the steam cooking chamber and a closed position to inhibit access to the steam cooking chamber through the access opening. A steam inlet path extends through one of the cooking chamber walls. A stationary nozzle unit is located within the cooking chamber and alongside the one of the cooking chamber walls for receiving steam from the steam inlet path. The nozzle unit includes multiple steam delivery nozzles disposed at stationary positions relative to the one of the cooking chamber walls. The multiple steam delivery nozzles are arranged and configured to emit steam substantially parallel to the one of the cooking chamber walls.

### TECHNICAL FIELD

The present application relates to steam cookers and more particularly to a steam cooker with steam delivery device.

### BACKGROUND

Steam cookers have been successfully employed by restaurants, hospitals and other food service operations to prepare quickly and conveniently large quantities of food. Typically, steam is generated in a steam generator and the generated steam is delivered into the cooking chamber of the steam cooker through a nozzle. It would be desirable to provide a steam cooker in which steam is delivered into the steam cooking chamber in a manner to provide an effective distribution of steam throughout the chamber.

### SUMMARY

In an aspect, a steam cooker includes a steam cooking chamber including left, right, top, bottom and rear walls, a front access opening and a door moveable between an open position to allow access to the steam cooking chamber and a closed position to inhibit access to the steam cooking chamber through the access opening. A steam inlet path extends through one of the cooking chamber walls. A stationary nozzle unit is located within the cooking chamber and alongside the one of the cooking chamber walls for receiving steam from the steam inlet path. The nozzle unit includes multiple steam delivery nozzles disposed at stationary positions relative to the one of the cooking chamber walls. The multiple steam delivery nozzles are arranged and configured to emit steam substantially parallel to the one of the cooking chamber walls.

In another aspect, a method of cooking a food product within a cooking chamber of a steam cooker is provided. The method includes routing steam along a steam inlet path through a wall of the cooking chamber to multiple steam delivery nozzles. The multiple steam delivery nozzles are in stationary positions relative to the wall. Steam is emitted into the cooking chamber from the steam delivery nozzles substantially parallel to the wall.

### BRIEF DESCRIPTION OF DRAWINGS

FIG. 1 is a perspective view of a steam cooking chamber including an embodiment of a steam delivery device;

FIG. 2 is a side view of the steam delivery device of FIG. 1;

FIG. 3 is an exploded view of the steam delivery device of FIG. 2;

FIG. 4 is a section view of an embodiment of a nozzle unit of the steam delivery device along line 4-4 of FIG. 3;

FIG. 5 is a section view of an embodiment of a axial conduit of the steam delivery device along line 5-5 of FIG. 3;

FIG. 6 is a section view of the steam delivery device along line 6-6 of FIG. 2;

FIG. 7 is a side view of the steam delivery device of FIG. 2 connected at a wall;

FIG. 8 is a front view of the steam cooking chamber of FIG. 1 with food product therein; and

FIG. 9 is a schematic, top section view of an embodiment of a cooking chamber including the steam delivery device of FIG. 2.

### DESCRIPTION

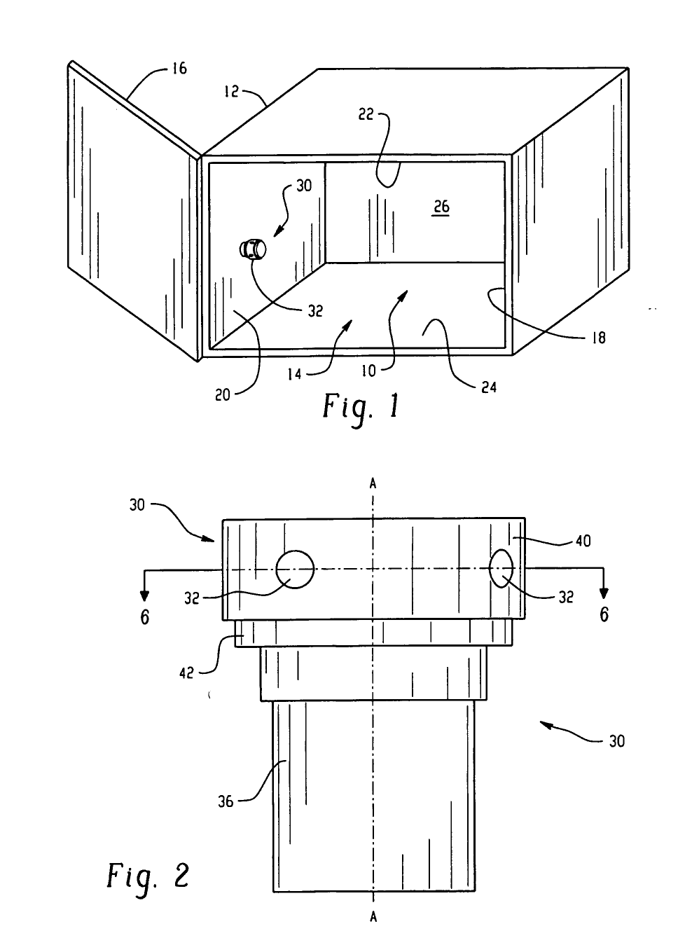

Referring to FIG. 1, a steam cooking chamber 10 of a steam cooker is shown. The steam cooking chamber 10 includes a housing 12 and an access opening 14 providing access to the cooking chamber 10. To close the access opening 14, a door 16 is hingedly attached to the housing 12. The housing 12 includes opposing sidewalls 18 and 20, opposing top and bottom walls 22 and 24 extending between the sidewalls and a rear wall 26 extending between the top, bottom and sidewalls at the rear of the cooking chamber 10.

The cooking chamber 10 is connected to a steam source (not shown), such as a steam generator, that is capable of providing steam for use during a cooking operation. The generated steam is outlet into the cooking chamber 10 using a steam delivery device 30 that is fixedly mounted within the cooking chamber at one of the walls 18, 20, 22, 24 or 26. As shown, the delivery device is mounted within the cooking chamber 10 at the sidewall 20, but the delivery device may be attached at any of the other walls.

The steam delivery device 30 extends substantially perpendicularly from the sidewall 20 into the cooking chamber 10 and includes multiple steam delivery nozzles or outlets 32 that are used to deliver steam into the cooking chamber. As will be described in greater detail below, the steam nozzles 32 are located at stationary positions in the cooking chamber 10 to direct steam into the cooking chamber in directions substantially parallel or otherwise along an interior surface 34 of the sidewall 20. Directing steam radially from the steam delivery device in multiple directions along the sidewall 20 can provide increased distribution of the steam throughout the cooking chamber 10.

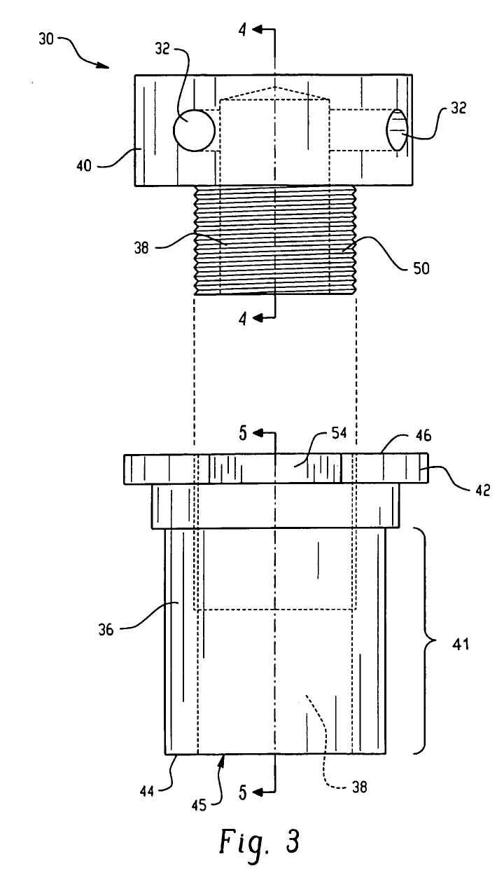

Referring to FIGS. 2 and 3, where the steam delivery device is shown in assembled and exploded views respectively, the illustrated steam delivery device 30 includes an axial conduit 36 forming a steam path 38 (shown by dotted lines in FIG. 3) that extends along a longitudinal axis A and a steam delivery nozzle unit 40 also forming part of the steam path 38 that includes the steam nozzles 32. The steam nozzles 32 are arranged in a circumferential array about the axis A with each steam nozzle 32 of the array spaced apart from an adjacent steam nozzle about the steam delivery nozzle unit's periphery. The exact number and location of the steam nozzles 32 can be varied.

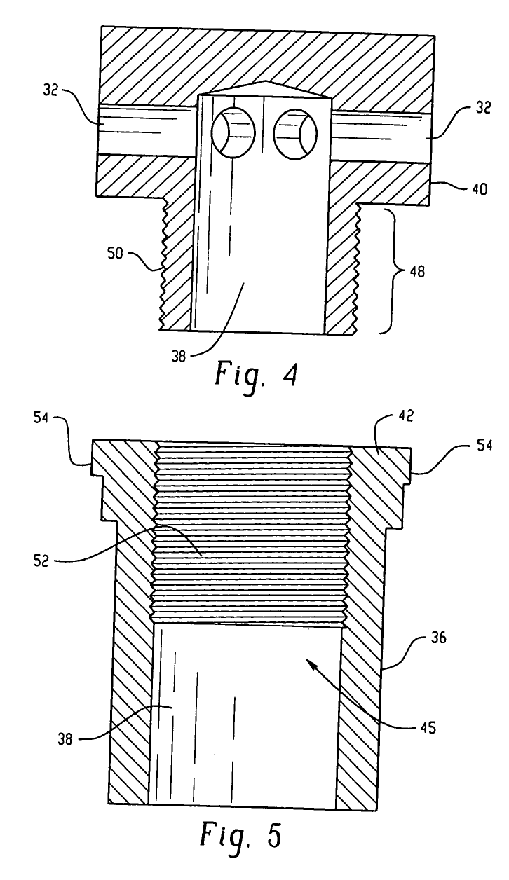

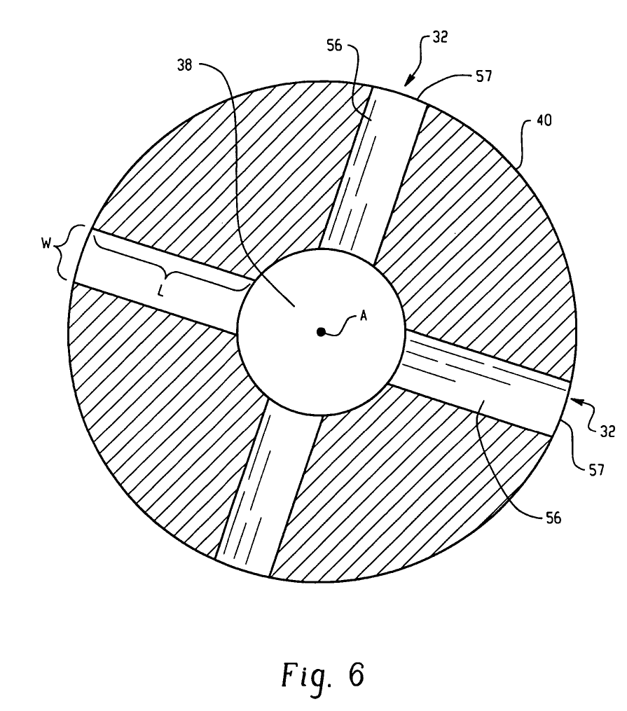

Referring to FIG. 3, the illustrated axial conduit 36 includes a mounting portion 42 of reduced outer diameter for mounting the steam delivery device 30 within the cooking chamber 10 (e.g., using a threaded connection), a flange 42 and a bore 45 extending between ends 44, 46 of the axial conduit. Referring also to FIGS. 4 and 5, bore 45 is sized to receive and connect to a connecting portion 48 of the steam delivery nozzle unit 40 so that steam can be delivered through the steam path 38 toward the steam delivery nozzle unit. In some embodiments such as the one depicted, the axial conduit 36 and steam delivery nozzle unit 40 are connected via a mating threaded connection with the steam delivery nozzle unit having a threaded outer surface 50 and the axial conduit 36 having a corresponding threaded inner surface 52. Other connecting structure is possible, such as a clamp, friction or press fit, etc. The connection between the axial conduit 36 and the steam delivery nozzle unit 40 can form an air-tight and/or water-tight seal to inhibit steam leak between the members during use. To aid in grasping and rotating the steam delivery nozzle unit 40, e.g., to aid a user in fastening and unfastening the steam delivery device 30 from within the cooking chamber 10, the flange 42 includes flattened portions 54 (FIG. 3).

Referring now to FIG. 6, nozzles 32 of the delivery nozzle unit 40 include nozzle steam channels 56 that provide communication between nozzle outlets 57 and the steam path 38. The nozzle steam channels 56 extend substantially perpendicular to the axis A of the steam path 38, however, other configurations are possible where the steam channels 56 extend at other angles to the steam path. To provide for controlled steam delivery into the cooking chamber 10, in some embodiments, the steam channels 56 have a length L that is about the same as a width W (e.g., diameter in the case of circular steam nozzles) of their associated steam nozzle outlets 57 or more. In embodiments including relatively more nozzles 32 (e.g., six to eight nozzles 32 or more), L may be greater than in embodiments utilizing less nozzles (e.g., less than six, such as four). Preferably, L of the steam channels 56 is at least about two times W of the associated steam nozzle outlet 57 or more. In other embodiments, L may be at least about W. A higher L/W ratio can increase the flow coefficient or discharge coefficient of the nozzles 32 as compared to the ideal, which can provide steam flows having higher velocities downstream of the nozzles, thus producing a more effective flow and distribution of steam into the chamber. The higher LAW ratio can also determine the directionality of the steam flows and assure the steam flows are projected from the nozzles 32 generally parallel to the wall. In instances where steam is delivered under relatively low pressures (e.g., about two psi or less), it may be desirable to utilize fewer nozzles such as four nozzles 32. Conversely, where steam is delivered under relatively high pressures (e.g., greater than 2 psi), it may be desirable to utilize a greater number of nozzles such as six to eight nozzles 32.

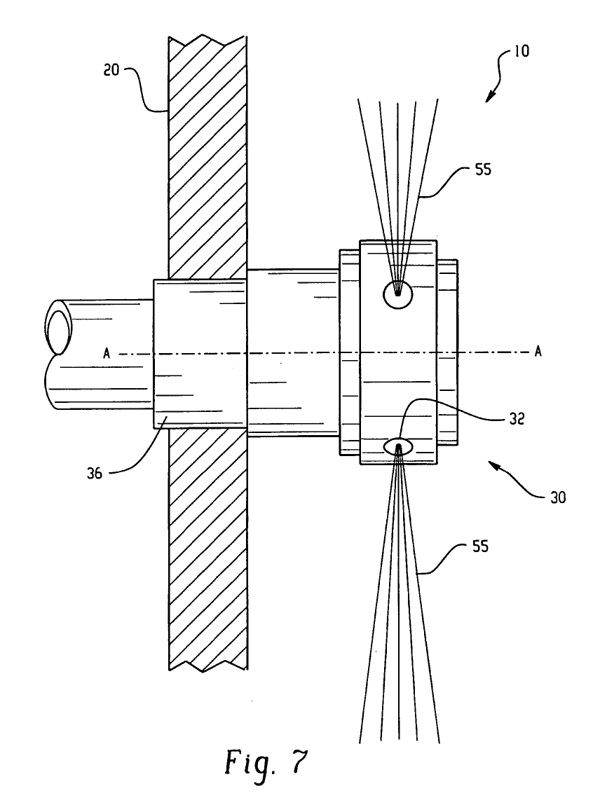

FIG. 7 shows the steam delivery device 30 connected to a steam source at wall 20 of the cooking chamber 10. As described above, and as reflected by the lines emanating from the nozzles 32, the steam delivery device 30 is capable of distributing steam 55 generated at the steam source and delivered to the cooking chamber in multiple radial directions along or substantially parallel to the wall 20 through which the axial conduit 36 and steam path extend. In some embodiments, the steam delivery device 30 is located outwardly beyond the wall 20 such that steam can be delivered relatively unimpeded along the surface of the wall. By forming the chamber 10 with curved transitions 80, 82, 84, 86 between walls 18, 20, 26 (as shown schematically in FIG. 9), the flow of steam (represented by the arrows) along the walls and around the food product can be further enhanced. It is also possible that a cage (e.g., formed of a metal screen or bars) might be placed over the steam delivery device 30 to inhibit contact with the steam delivery device while still allowing the steam to enter the cooking chamber.

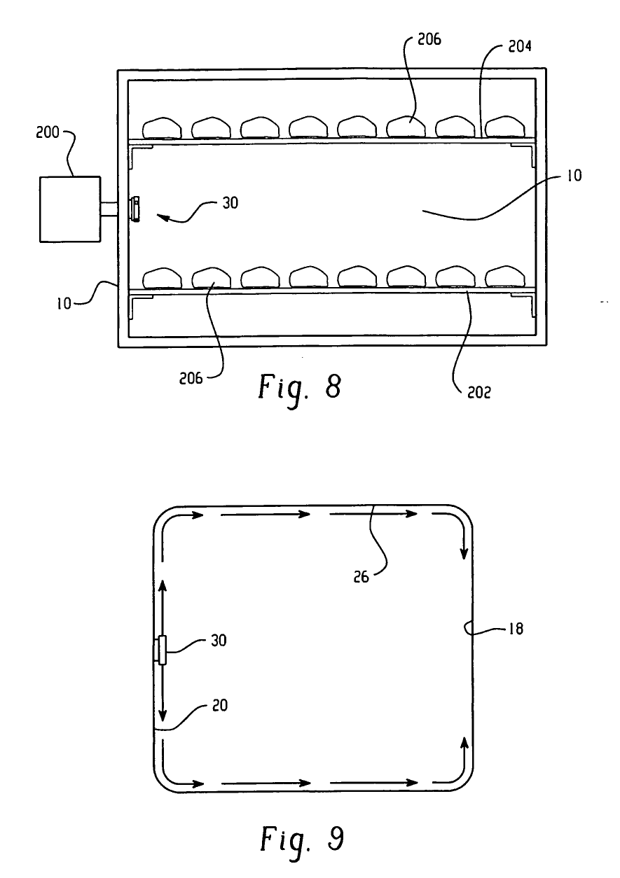

FIG. 8 shows a schematic front elevation in which the steam cooking chamber 10 includes an upper and lower rack 202 and 204 supporting food product 206 to be steamed within the chamber and schematically showing a source of steam 200 alongside the chamber. Steam source 200 could be, for example, a boiler of any suitable configuration, including a boiler providing steam at a temperature of around 212° F. or a boiler configured to provide superheated steam at temperatures upward of 220° F.

The axial conduit 36 and steam delivery nozzle unit 40 can be formed of any suitable material, including stainless steel and brass. Any suitable method can be used to form the axial conduit 36 and delivery nozzle unit 40, such as casting and/or machining.

It is to be clearly understood that the above description is intended by way of illustration and example only and is not intended to be taken by way of limitation, and that changes and modifications are possible. For example, multiple steam inlet paths 38 may be used to direct steam from the source of steam to the nozzles 32. Accordingly, other embodiments are contemplated and modifications and changes could be made without departing from the scope of this application as expressed by any claims now included or hereafter added.

What is claimed is:

1. A steam cooker, comprising:
a steam cooking chamber including left, right, top, bottom and rear walls, a front access opening and a door moveable between an open position to allow access to the steam cooking chamber and a closed position to inhibit access to the steam cooking chamber through the access opening;
a steam inlet path extending through one of the cooking chamber walls; and
a single stationary nozzle unit within the cooking chamber and alongside the one of the cooking chamber walls for receiving steam from the steam inlet path, the nozzle unit including multiple steam delivery nozzles disposed at stationary positions relative to the one of the cooking chamber walls, the multiple steam delivery nozzles being arranged and configured to emit steam substantially parallel to the one of the cooking chamber walls.

2. The steam cooker of claim 1, wherein only one steam inlet path extends through one of the cooking chamber walls.

3. The steam cooker of claim 1, wherein a pressure of steam delivered along the steam path is less than about 2 psi.

4. The steam cooker of claim 1, wherein each steam delivery nozzle includes an outlet that is in communication with the steam path via a steam channel, the steam channel having a length that is greater than or equal to twice a diameter of the outlet.

5. The steam cooker of claim 4, wherein the steam path extends along a longitudinal axis that is substantially perpendicular to the one of the cooking chamber walls.

6. The steam cooker of claim 5, wherein the steam channels are substantially perpendicular to the longitudinal axis of the steam path.

7. The steam cooker of claim 5, wherein the outlets are arranged about the longitudinal axis in a circumferential array.

8. The steam cooker of claim 5 comprising a steam conduit defining at least a portion of the steam path, the nozzle unit connected to the steam conduit.

9. The steam cooker of claim 8, wherein the steam nozzle unit is threadably connected to the steam conduit.

10. The steam cooker of claim 1, wherein the one of the cooking chamber walls is either the left or right wall.

11. The steam cooker of claim 1, further comprising a food product within the steam cooking chamber, wherein the food product is located at multiple levels within the steam cooking chamber, including a level above the single steam path and a level below the steam path.

12. The steam cooker of claim 1 further comprising curved transitions between the left and rear walls and the right and rear walls.

13. A method of cooking a food product within a cooking chamber of a steam cooker, the method comprising:
routing steam along a steam inlet path through a wall of the cooking chamber to multiple steam delivery nozzles, the multiple steam delivery nozzles being in stationary positions relative to the wall; and
emitting steam into the cooking chamber from the steam delivery nozzles substantially parallel to the wall.

14. The method of claim 13, wherein only one steam inlet path extends through the wall of the cooking chamber.

15. The method of claim 13, wherein the steam is routed along the steam path at a pressure of less than about 2 psi.

16. The method of claim 13 further comprising providing communication between the steam path and a steam outlet of each steam delivery nozzle via a steam channel that extends substantially perpendicular to the steam path.

17. The method of claim 16, wherein each steam channel has a length that is greater than or equal to twice a diameter of the associated steam outlet.

18. The method of claim 16, wherein the steam path extends substantially perpendicular to the wall.

19. The method of claim 18, wherein the wall is either a left wall or a right wall of the cooking chamber.

20. The method of claim 13 further comprising placing food product within the cooking chamber at a level above the steam path and a level below the steam path.
